(19) United States
(12) Patent Application Publication
(10) Pub. No.: US 2026/0158475 A1
(43) Pub. Date: Jun. 11, 2026

(54) METHODS FOR PREPARING C2 TO C4 HYDROCARBONS AND FORMULATED HYBRID CATALYSTS

(71) Applicants: Dow Global Technologies LLC, Midland, MI (US); Dow Silicones Corporation, Midland, MI (US)

(72) Inventors: Glenn Pollefeyt, Terneuzen (NL); Vera Santos, Terneuzen (NL); Ewa A. Tocha-Bielak, Terneuzen (NL); David F. Yancey, Midland, MI (US); Florian Geyer, Wiesbaden (DE); Steven J. Rozeveld, Midland, MI (US); Stuart Leadley, Seneffe (BE); Andrzej Malek, Midland, MI (US)

(73) Assignees: Dow Global Technologies LLC, Midland, MI (US); Dow Silicones Corporation, Midland, MI (US)

(21) Appl. No.: 18/995,437

(22) PCT Filed: Jul. 21, 2023
(86) PCT No.: PCT/US2023/070660

§ 371 Date: Jan. 16, 2025

Related U.S. Application Data
(60) Provisional application No. 63/391,481, filed on Jul. 22, 2022.

(51) Int. Cl. B01J 23/825; B01J 29/85; B01J 35/40; B01J 35/63; B01J 37/00

(52) U.S. Cl. CPC B01J 23/825; B01J 29/85; B01J 35/40; B01J 35/633; B01J 37/0009

(57) ABSTRACT

According to embodiments, a process for preparing a formed hybrid catalyst may comprise mixing a metal oxide catalyst component and a microporous catalyst component, adding a binder to the metal oxide catalyst component and the microporous catalyst component to form a paste, wherein the binder is a colloidal solution, suspension, or gel of a binder precursor comprising oxides or hydroxides of aluminum, oxides or hydroxides of zirconium, or mixtures thereof, and extruding the paste to produce the formed hybrid catalyst. The metal oxide catalyst component may comprise gallium oxide and zirconia, wherein the zirconia has a macroporosity fraction that is less than 0.3 and the microporous catalyst component may comprise a molecular sieve having 8-MR (Member Ring) pore openings. The formed hybrid catalyst may be used in a process to convert a feed stream into a product stream comprising C₂ to C₄ hydrocarbons.

### CROSS REFERENCE TO RELATED APPLICATION

This application claims the benefit of U.S. Provisional Patent Application Ser. No. 63/391,481 filed Jul. 22, 2022, which is hereby incorporated by reference in its entirety.

### TECHNICAL FIELD

The present disclosure relates to processes that efficiently convert various carbon-containing streams to C₂ to C₄ hydrocarbons. In particular, the present disclosure relates to the preparation of formulated hybrid catalysts and the application of using the formulated hybrid catalysts to achieve a high conversion of carbon-containing gas feeds resulting in good conversion of carbon and high yield of desired products.

### BACKGROUND

For a number of industrial applications, hydrocarbons are used, or are a starting material used, to produce plastics, fuels, and various downstream chemicals. Such hydrocarbons include C₂ to C₄ materials, such as ethene, propene, and butenes (also commonly referred to as ethylene, propylene, and butylenes, respectively). A variety of processes for producing these lower hydrocarbons have been developed, including petroleum cracking and various synthetic processes.

Synthetic processes for converting feed carbon to desired products, such as hydrocarbons, are known. Different types of catalysts have been explored, as well as different kinds of feed streams and proportions of feed stream components.

Many of these synthetic processes have low carbon conversion and much of the feed carbon either does not get converted and exits the process in the same form as the feed carbon or is converted to CO₂. In addition, these synthetic processes can have low stability over time and the catalyst rapidly loses its activity for carbon conversion to desirable products. Accordingly, a need exists for processes and catalytic systems that improve C₂ to C₄ hydrocarbon production, especially as time on stream increases.

### SUMMARY

Embodiments of the present disclosure address these and other needs by the methods of preparation of formulated hybrid catalysts and processes of using such catalysts. A formulated hybrid catalyst, as described herein, comprises a combination of a metal oxide catalyst component, a microporous catalyst component, and a binder. The metal oxide catalyst component and the microporous catalyst component may be combined into a single catalyst body using the binder. This formulated hybrid catalyst may then be used for the direct conversion of a feed stream comprising hydrogen gas and a carbon-containing gas, such as syngas, to C₂ to C₄ hydrocarbons. The metal oxide catalyst component and the microporous catalyst component may operate in tandem so that the formulated hybrid catalyst is able to directly and selectively convert a feed stream comprising hydrogen and carbon-containing gas, such as syngas, to C₂ to C₄ hydrocarbons with a high olefin/paraffin ratio.

According to one or more embodiments of the present disclosure, a process for preparing a formed hybrid catalyst may comprise mixing a metal oxide catalyst component and a microporous catalyst component, wherein the metal oxide catalyst component comprises gallium oxide and zirconia, where the zirconia has a macroporosity fraction that is less than 0.3, and the microporous catalyst component comprises a molecular sieve having 8-MR (Member Ring) pore openings, adding a binder to the metal oxide catalyst component and the microporous catalyst component to form a paste, wherein the binder is a colloidal solution, suspension, or gel of a binder precursor comprising oxides or hydroxides of aluminum, oxides or hydroxides of zirconium, or mixtures thereof, and extruding the paste to produce the formed hybrid catalyst.

According to one or more embodiments of the present disclosure, a process for preparing C₂ to C₄ hydrocarbons may comprise introducing a feed stream comprising hydrogen gas and a carbon-containing gas selected from the group consisting of carbon monoxide, carbon dioxide, and mixtures thereof into a reaction zone of a reactor and converting the feed stream into a product stream comprising C₂ to C₄ hydrocarbons in the reaction zone in the presence of a formed hybrid catalyst, where the formed hybrid catalyst may comprise a metal oxide catalyst component comprising gallium oxide and zirconia, wherein the zirconia has a macroporosity fraction that is less than 0.3, a microporous catalyst component that is a molecular sieve having 8-MR (Membered Ring) pore openings, and a binder comprising alumina, zirconia, or mixtures thereof.

Additional features and advantages will be set forth in the detailed description that follows and, in part, will be readily apparent to those skilled in the art from that description or recognized by practicing the embodiments described herein, including the detailed description which follows in addition to the claims.

It is to be understood that both the foregoing general description and the following detailed description describe various embodiments and are intended to provide an overview or framework for understanding the nature and character of the claimed subject matter.

### DETAILED DESCRIPTION

Reference will now be made in detail to embodiments of methods for preparing the formulated hybrid catalyst and to processes for forming C₂ to C₄ hydrocarbons from a feed stream comprising hydrogen gas and a carbon-containing gas. As used herein, “a carbon-containing gas” refers to a gas selected from carbon monoxide, carbon dioxide, and mixtures thereof. As used herein, “synthesis gas” or “syngas” refers to a gas comprising hydrogen gas and a carbon-containing gas. In one or more embodiments, methods for preparing a formulated hybrid catalyst may comprise mixing a metal oxide catalyst component and a microporous catalyst component to form a mixture, adding a binder to the mixture of the metal oxide catalyst component and the microporous catalyst component to form a paste, and extruding the paste to produce the formulated hybrid catalyst, followed by drying and calcination. The metal oxide catalyst component may comprise gallium oxide and zirconia, where the zirconia may have a macroporosity fraction of less than 0.30. The microporous catalyst component may comprise a molecular sieve having 8 MR (Member Ring) pore openings. The binder may be a colloidal solution, suspension, or gel of a binder precursor comprising oxides or hydroxides of aluminium, oxides or hydroxides of zirconium, or mixtures thereof.

In one or more embodiments, processes for preparing C₂ to C₄ hydrocarbons may comprise introducing a feed stream comprising hydrogen gas and a carbon-containing gas selected from a group consisting of carbon monoxide, carbon dioxide, and mixtures thereof into a reaction zone of a reactor and converting the feed stream into a product stream comprising C₂ to C₄ hydrocarbons in the reaction zone in the presence of a formulated hybrid catalyst. The formulated hybrid catalyst may be formed by the methods for preparing a formulated hybrid catalyst as described herein.

The use of formulated hybrid catalysts is known in the field of hydrocarbon products, such as diesel, or aromatics. However, many known formulated hybrid catalysts are inefficient for forming C₂ to C₄ hydrocarbons, both for C₂-C₄ paraffins and for C₂ to C₄ olefins, from a feed stream comprising hydrogen gas and a carbon-containing gas, because they exhibit a low feed carbon conversion and/or deactivate quickly as they are used. In contrast, the formulated hybrid catalysts disclosed and described herein exhibit a high and steady yield of C₂ to C₄ hydrocarbons even as the catalyst time on stream increases when compared to hybrid catalysts where the metal oxide catalyst component comprises zirconia with a relatively high macroporosity fraction (indicating a higher fraction of larger pores). The preparation and composition of such formulated hybrid catalysts used in embodiments is discussed below.

In one or more embodiments, the term “metal oxide catalyst component” may refer to a metal oxide catalyst support material that is coated with one or more dopants, for example, the metal oxide catalyst component may comprise a zirconia support material coated with one or more dopants comprising gallium oxide and a rare earth oxide. In one or more embodiments, the term “microporous catalyst component” may refer to a molecular sieve zeolitic component comprising crystalline aluminosilicates having a three-dimensional interconnecting network of [SiO₄] and [AlO₄]⁻ tetrahedra. In one or more embodiments, the term “microporous catalyst component” may refer to a molecular sieve zeotype component comprising crystalline silicoaluminophosphates having a three-dimensional interconnecting network of [PO₄]⁻ and [AlO₄]⁻ tetrahedra, in which aluminum and/or phosphorus are partially replaced by silicon. In one or more embodiments, the term “binder” may refer to a material that is able to bind the metal oxide catalyst component with the microporous catalyst component in order to combine these components into a single catalyst body.

In one or more embodiments, the metal oxide catalyst component may comprise zirconia, where the zirconia acts as a metal oxide support. The term “metal oxide support” may refer to a support material that supports the other components of the metal oxide catalyst component, for example, gallium oxide and rare earth oxide. In some embodiments, the zirconia of the metal oxide catalyst component may comprise micropores. The term “micropores” may refer to the pores of a material where one or more pores are less than 2 nm in diameter. In some embodiments, the zirconia of the metal oxide catalyst component may comprise mesopores. The term “mesopores” may refer to the pores of a material where one or more pores are 2-50 nm in diameter. In some embodiments, the zirconia of the metal oxide catalyst component may comprise macropores. The term “macropores” may refer to the pores of a material where one or more pores are greater than or equal to 80 nm in diameter. It has been discovered herein that substantial amounts of macropores in the zirconia increases the deactivation of the hybrid catalyst. Accordingly, it is desired to have a low amount of macropores present in the zirconia.

The term “macroporosity fraction” may refer to the macroporous pore volume of the zirconia support over the total pore volume of pores of the zirconia support with a size below 500 nm. In order to test the macroporosity fraction, mercury porosimetry testing may be used where the porosity of the zirconia is measured by immersing the material in mercury and applying controlled pressure to the system so that mercury can penetrate into the pores of the material. Based on the pressure it takes to force the mercury into certain pores of the zirconia support, the pore diameter and pore volume may be calculated. Correlating the pore diameter and the associated pressure can be achieved using Formula I below, where D is the diameter of the zirconia support pore, P is the pressure it takes for mercury to penetrate the zirconia support pore, γ is the surface tension of the mercury, and θ is the contact angle between the zirconia and the mercury:

$$D = \frac{- 4 * γ * cos θ}{P} \qquad ( Formula I )$$

For example, when a NorPro SZ31164 zirconia support was tested using mercury porosimetry, it was found that the total intrusion volume of the mercury into the macropores of the zirconia support (i.e., 80-500 nm diameter pores) was 0.0406 mL/g and the total intrusion volume of the mercury into all pores with diameters ranging from 3-500 nm was 0.294 mL/g, thus resulting in a macroporosity fraction of 0.138. Without being bound by a theory, it is believed that a lower macroporosity fraction of the zirconia support results in the formulated hybrid catalyst achieving a higher conversion of compounds in a feed stream comprising hydrogen gas and a carbon-containing gas and having a lower deactivation rate.

In embodiments, the metal oxide catalyst component comprises gallium oxide. As used herein, “gallium oxide” refers to gallium in various oxidation states. In embodiments, gallium oxide can be deposited on the surface of zirconia or be in solid solution with zirconia. In other embodiments, gallium oxide may include, but is not limited to, Ga₂O₃, GaO(OH), and Ga₅O₇(OH). Gallium oxide can also include polymorphs of Ga₂O₃, such as monoclinic (β-Ga₂O₃), rhombohedral (α-Ga₂O₃), defective spinel (γ-Ga₂O₃), cubic (δ-Ga₂O₃), or orthorhombic (ε-Ga₂O₃) structures. In other embodiments, gallium oxide may include gallium in more than one oxidation state. For example, individual gallium may be in different oxidation states. Gallium oxide is not limited to comprising gallium in homogenous oxidation states.

As a summary, the formulated hybrid catalysts closely couple independent reactions on each of the two independent catalysts. In the first step, a feed stream comprising hydrogen gas (H₂) and a carbon-containing gas selected from the group consisting of carbon monoxide (CO), carbon dioxide (CO₂), or a mixture of CO and CO₂, such as syngas, is converted into an intermediate(s) such as oxygenated hydrocarbons. In the subsequent step, these intermediates are converted into a product stream comprising hydrocarbons (mostly short chain hydrocarbons, such as, for example, C₂ to C₄ hydrocarbons). The continued formation and consumption of the intermediate oxygenates formed in the first step by the reactions of the second step ensures that there is no thermodynamic limit on conversions.

In one or more embodiments, the formulated hybrid catalyst has a particle size from 0.5 mm to 6.0 mm. For example, the formulated hybrid catalyst may have a particle size of at least 0.5 mm, at least 1.0 mm, at least 1.5 mm, at least 2.0 mm, at least 2.5 mm, at least 3.0 mm, at least 3.5 mm, at least 4.0 mm, at least 4.5 mm, at least 5.0 mm, at least 5.5 mm, or even 6.0 mm. In embodiments, the formulated hybrid catalyst may have a particle size that is less than 3.0 mm, such as less than 2.5 mm, less than 2.0 mm, less than 1.5 mm, less than 1.0 mm, or less than 0.5 mm. In embodiments, the formulated hybrid catalyst may have a particle size ranging from 0.5 mm to 5.5 mm, from 0.5 mm to 5.0 mm, from 0.5 mm to 4.5 mm, from 0.5 mm to 4.0 mm, from 0.5 mm to 3.5 mm, from 0.5 mm to 3.0 mm, from 0.5 mm to 2.5 mm, from 0.5 mm to 2.0 mm, or from 0.5 mm to 1.5 mm. In embodiments, the formulated hybrid catalyst may have a particle size ranging from 1.0 mm to 6.0 mm, from 1.5 mm to 6.0 mm, from 2.0 mm to 6.0 mm, from 2.5 mm to 6.0 mm, from 3.0 mm to 6.0 mm, from 3.5 mm to 6.0 mm, from 4.0 mm to 6.0 mm, from 4.5 mm to 6.0 mm, from 5.0 mm to 6.0 mm, or from 5.5 mm to 6.0 mm. The particle size may be essentially the shortest dimension of the catalyst particle. For example, when the formulated hybrid catalyst has a hollow cylinder or a ring shape, the particle size is the thickness of the hollow cylinder wall. When the formulated hybrid catalyst has a spherical shape, the particle size is the diameter of the sphere. The particle size of the formulated hybrid catalyst may be controlled by choice of the extrusion die diameter and measured by dynamic image analysis methods.

In one or more embodiments, the zirconia of the metal oxide catalyst component may have a macroporosity fraction of less than 0.30, such as having a macroporosity fraction of less than 0.25, less than 0.20, less than 0.15, or even less than 0.10. In one or more embodiments, the macroporosity fraction may be from 0.05 to 0.25, from 0.10 to 0.25, or from 0.10 to 0.20. In embodiments, the macroporosity fraction may be from 0.05 to 0.25, from 0.05 to 0.20, from 0.05 to 0.15, or from 0.0 to 0.10. In embodiments, the macroporosity fraction may be from 0.10 to 0.30, from 0.15 to 0.30, from 0.20 to 0.30, or from 0.25 to 0.30.

The metal oxide catalyst component may comprise gallium oxide and/or zirconia (ZrO₂). As used herein, the zirconia used in embodiments disclosed and described herein in the metal oxide catalyst component of the formulated hybrid catalyst may be “phase pure zirconia”, which is defined herein as zirconia to which no other materials have intentionally been added during formation. Thus, “phase pure zirconia” includes zirconia with small amounts of components other than zirconium (including oxides other than zirconia) that are unintentionally present in the zirconia as a natural part of the zirconia formation process, such as, for example, hafnium (Hf). Accordingly, as used herein “zirconia” and “phase pure zirconia” are used interchangeably unless specifically indicated otherwise. In other embodiments, the zirconia can be non-phase pure zirconia, such as zirconia doped with calcium, yttria, lanthanum, cerium or rare earth elements.

In one or more embodiments, the composition of the metal oxide catalyst component is designated by a weight percentage of the gallium to the pure zirconia (accounting for ZrO₂ and Ga₂O₃ stoichiometry). In one or more embodiments, the composition of the metal oxide catalyst component is designated by weight percentage of gallium. For example, the metal oxide catalyst component may comprise from 0.1 wt. % to 10 wt. % gallium, such as from 0.1 wt. % to 9 wt. %, from 0.1 wt. % to 8 wt. %, from 0.1 wt. % to 7 wt. %, from 0.1 wt. % to 6 wt. %, from 0.1 wt. % to 5 wt. %, from 0.1 wt. % to 4 wt. %, from 0.1 wt. % to 3 wt. %, from 0.1 wt. % to 2 wt. %, from 0.5 wt. % to 10 wt. %, from 1 wt. % to 10 wt. %, from 2 wt. % to 10 wt. %, from 3 wt. % to 10 wt. %, from 4 wt. % to 10 wt. %, from 5 wt. % to 10 wt. %, from 6 wt. % to 10 wt. %, from 7 wt. % to 10 wt. %, from 8 wt. % to 10 wt. %, from 9 wt. % to 10 wt. %, from 1 wt. % to 5 wt. %, from 3 wt. % to 10 wt. %, or from 3 wt. % to 7 wt. % gallium.

In embodiments, the metal oxide catalyst component may comprise lanthanide oxide. In other embodiments, additional elements from the group of rare earth elements, lanthanides, and/or transition metals, such as Ni, Pd or Pt, are co-deposited with a gallium precursor or introduced only when the mixed composition including gallium oxide and zirconia has first been prepared.

In embodiments disclosed herein, the composition of the metal oxide catalyst component may be designated by a weight percentage of the lanthanide oxide metal to the pure zirconia (accounting for ZrO₂ stoichiometry). In one or more embodiments, the composition of the metal oxide catalyst component may be designated by weight percentage of lanthanide element on oxidic basis. According to one or more embodiments, the metal oxide catalyst component may comprise from 0.1 wt. % to 7 wt. % lanthanide, such as from 0.5 wt. % to 7 wt. %, from 1 wt. % to 7 wt. %, from 2 wt. % to 7 wt. %, from 3 wt. % to 7 wt. %, from 4 wt. % to 7 wt. %, from 5 wt. % to 7 wt. %, from 6 wt. % to 7 wt. %, from 0.1 wt. % to 6 wt. %, from 0.1 wt. % to 5 wt. %, from 0.1 wt. % to 4 wt. %, from 0.1 wt. % to 3 wt. %, from 0.1 wt. % to 2 wt. %, from 0.1 wt. % to 1 wt. %, from 0.5 wt. % to 5 wt. %, from 0.5 wt. % to 3 wt. %, from 3 wt. % to 7 wt. %, or from 5 wt. % to 7 wt. % lanthanide.

In embodiments, one method for making the metal oxide catalyst component of the hybrid catalyst is by incipient wetness impregnation. In such a method, an aqueous mixture of a gallium precursor material, such as gallium (III) nitrate hydrate (Ga(NO₃)₃·xH₂O), and/or an aqueous mixture of a rare earth metal precursor material, such as lanthanum(III) nitrate hexahydrate (La(NO₃)₃·6H₂O), are added to zirconia powder. In embodiments, the aqueous mixture comprising the gallium precursor material and/or the rare earth metal precursor material may be sprayed, added dropwise, or any other similar method such that there is a uniform, or near uniform, distribution of the aqueous mixture over the zirconia. This may be accomplished by mixing the zirconia powder and the aqueous mixture. In other embodiments, the gallium oxide and/or rare earth oxide may be deposited or distributed on the zirconia oxide by chemical vapor deposition (CVD) method. However, the method for making the metal oxide catalyst component of the hybrid catalyst is not particularly limited and any method that can apply a fine layer of gallium oxide and rare earth oxide on the surface of zirconium oxide can be used according to embodiments. It should be understood that the total amount of gallium precursor and rare earth metal precursor that are mixed with the zirconia will be determined on the desired target amount of gallium and rare earth metal in the metal oxide catalyst component.

According to embodiments, the zirconia particles may include zirconia particles having a crystalline structure. In embodiments, the zirconia particles may include zirconia particles having a monoclinic structure. In one or more embodiments, the zirconia particles consist essentially of or consist of crystalline zirconia particles, and in embodiments, the zirconia particles consist essentially of or consist of monoclinic zirconia particles.

In embodiments, the surface area of the zirconia particles may be greater than or equal to 5 meters squared per gram (m²/g). For example, the surface area of the zirconia particles may be at least 5 m²/g, at least 10 m²/g, at least 20 m²/g, at least 50 m²/g, at least 75 m²/g, at least 100 m²/g, at least 125 m²/g, or at least 150 m²/g. In embodiments, the surface area of the zirconia particle may be from 5 m²/g to 200 m²/g, from 10 m²/g to 200 m²/g, from 20 m²/g to 200 m²/g, such as from 30 m²/g to 200 m²/g, from 40 m²/g to 200 m²/g, from 50 m²/g to 200 m²/g, from 60 m²/g to 200 m²/g, from 70 m²/g to 200 m²/g, from 80 m²/g to 200 m²/g, from 90 m²/g to 200 m²/g, from 100 m²/g to 200 m²/g, from 110 m²/g to 200 m²/g, from 120 m²/g to 200 m²/g, from 130 m²/g to 200 m²/g, or from 140 m²/g to 200 m²/g. In embodiments, the surface area of the zirconia particles may be from 5 m²/g to 180 m²/g, from 5 m²/g to 160 m²/g, from 5 m²/g to 140 m²/g, from 5 m²/g to 120 m²/g, from 5 m²/g to 100 m²/g, from 5 m²/g to 90 m²/g, from 5 m²/g to 80 m²/g, from 5 m²/g to 70 m²/g, from 5 m²/g to 60 m²/g, from 5 m²/g to 50 m²/g, from 5 m²/g to 40 m²/g, from 5 m²/g to 30 m²/g, from 5 m²/g to 20 m²/g, or from 5 m²/g to 10 m²/g. In embodiments, the surface area of the zirconia particles may be from 10 m²/g to 160 m²/g, from 20 m²/g to 130 m²/g, from 30 m²/g to 120 m²/g, from 40 m²/g to 110 m²/g, from 50 m²/g to 100 m²/g, from 60 m²/g to 90 m²/g, or from 70 m²/g to 80 m²/g.

Once the gallium precursor and zirconia particles are adequately mixed, the metal oxide catalyst component may be dried at temperatures less than 200 degrees Celsius (° C.), such as less than 175° C., less than 150° C., less than 100° C., or about 85° C. In embodiments, the metal oxide catalyst component may be dried at temperatures of from 40° C. to 200° C. In embodiments, the metal oxide catalyst component may be dried at temperatures of from 40° C. to 160° C., from 40° C. to 120° C., or from 40° C. to 80° C. In embodiments, the metal oxide catalyst component may be dried at temperatures of from 80° C. to 200° C., from 120° C. to 200° C., or from 160° C. to 200° C. Subsequent to the drying, the metal oxide catalyst component may be calcined at temperatures from 400° C. to 800° C., such as from 425° C. to 775° C., from 450° C. to 750° C., from 475° C. to 725° C., from 500° C. to 700° C., from 525° C. to 675° C., from 550° C. to 650° C., from 575° C. to 625° C., about 550° C., or about 600° C. After calcining, the composition of the metal oxide catalyst component is determined and reported as a weight percent of gallium referenced to the oxidic composition of the material.

It should be understood that according to embodiments, the metal oxide catalyst component may be made by other methods that eventually lead to intimate contact between the gallium precursor and zirconia. Some non-limiting instances include vapor phase deposition of Ga-containing precursors (either organic or inorganic in nature), followed by their controlled decomposition. Similarly, processes for dispersing liquid gallium metal can be amended by those skilled in the art to lead to intimate contact between the gallium precursor and zirconia.

In one or more embodiments, after the metal oxide catalyst component has been prepared—such as, for example, by the methods disclosed above—the metal oxide catalyst component may be mixed with a microporous catalyst component and a binder in order to form a single catalyst. The microporous catalyst component may be, in embodiments, selected from molecular sieves having 8-MR (member ring) pore openings and having a framework type selected from the group consisting of the following framework types: CHA, AEI, AFX, ERI, LEV, LTA, UFI, RTH, EDI, GIS, MER, RHO, and combinations thereof, the framework types corresponding to the naming convention of the International Zeolite Association. It should be understood that in embodiments, both aluminosilicate and silicoaluminophosphate frameworks may be used. Embodiments may include tetrahedral aluminosilicates, ALPOs (such as, for example, tetrahedral aluminophosphates), SAPOs (such as, for example, tetrahedral silicoaluminophosphates), and silica-only based tectosilicates. In certain embodiments, the microporous catalyst component may be silicoaluminophosphate having a Chabazite (CHA) framework type. Examples of these may include but are not necessarily limited to: CHA embodiments selected from SAPO-34 and SSZ-13 and AEI embodiments such as SAPO-18 and SSZ-39. Combinations of microporous catalyst components having any of the above framework types may also be employed. It should be understood that the microporous catalyst component may have different membered ring pore opening depending on the desired product. For instance, microporous catalyst component having 8-MR to 12-MR pore openings could be used depending on the desired product. However, to produce C₂ to C₄ hydrocarbons, a microporous catalyst component having 8-MR pore openings is used in embodiments.

The metal oxide catalyst component and the microporous catalyst component of the formulated hybrid catalyst may be mixed together by any suitable means to achieve homogenous mixing of all the components prior to extrusion. The metal oxide catalyst component and the microporous catalyst component can be initially mixed as powders to achieve homogeneity in suitable dry mixer, such as a ribbon or plow mixer. The binder precursor can be added to the mixture of the metal oxide catalyst component and the microporous catalyst component and mixed in a suitable heavy duty industrial mixer capable of handling thick paste formulations. Alternatively, the dry pre-mixed metal oxide catalyst component and the microporous catalyst component can be fed directly into the feeding screws of a screw extruder along with the peptized binder precursor composition and mixed directly in the screw extruder. The formulated hybrid catalyst may be extruded into a desired shape by any suitable extrusion method. Examples of shapes include spherical, near-spherical, cylindrical, etc. In embodiments, the metal oxide catalyst component may include from 1.0 wt. % to 85.0 wt. % of the formulated hybrid catalyst, such as from 5.0 wt % to 85.0 wt %, from 10.0 wt % to 85.0 wt %, from 15.0 wt % to 85.0 wt %, from 20.0 wt % to 85.0 wt %, from 25.0 wt % to 85.0 wt %, from 30.0 wt % to 85.0 wt %, from 35.0 wt % to 85.0 wt %, from 40.0 wt % to 85.0 wt %, from 45.0 wt % to 85.0 wt %, from 50.0 wt % to 85.0 wt %, from 55.0 wt % to 85.0 wt %, from 60.0 wt % to 85.0 wt %, from 65.0 wt % to 85.0 wt %, from 70.0 wt % to 85.0 wt %, or from 75.0 wt % to 85.0 wt %. In embodiments, the metal oxide catalyst component includes from 1.0 wt % to 85.0 wt %, from 1.0 wt % to 75.0 wt %, from 1.0 wt % to 70.0 wt %, from 1.0 wt % to 65.0 wt %, from 1.0 wt % to 60.0 wt %, from 1.0 wt % to 55.0 wt %, from 1.0 wt % to 50.0 wt %, from 1.0 wt % to 45.0 wt %, from 1.0 wt % to 40.0 wt %, from 1.0 wt % to 35.0 wt %, from 1.0 wt % to 30.0 wt %, from 1.0 wt % to 25.0 wt %, from 1.0 wt % to 20.0 wt %, from 1.0 wt % to 15.0 wt %, from 1.0 wt % to 10.0 wt %, or from 1.0 wt % to 5.0 wt %. In embodiments, the metal oxide catalyst component includes from 5.0 wt % to 85.0 wt % of the formulated hybrid catalyst, such as from 10.0 wt % to 80.0 wt %, from 15.0 wt % to 80.0 wt %, from 20.0 wt % to 80.0 wt %, from 25.0 wt % to 75.0 wt %, from 30.0 wt % to 70.0 wt %, from 35.0 wt % to 65.0 wt %, from 40.0 wt % to 60.0 wt %, or from 45.0 wt % to 55.0 wt %. In embodiments, the metal oxide catalyst component includes from 40.0 wt % to 80.0 wt % of the formulated hybrid catalyst, such as from 50.0 wt % to 75.0 wt %, from 50.0 wt % to 70.0 wt %, from 60.0 wt % to 80.0 wt %, from 60.0 wt % to 75.0 wt %, or from 60.0 wt % to 70.0 wt %.

The metal oxide catalyst component and the microporous catalyst component may be combined with any mass ratio of from 1:10 to 10:1, such as the mass ratio of metal oxide catalyst component to microporous catalyst component is 1:1, 1:2, 1:3, 1:4, 1:5, 1:6, 1:7, 1:8, 1:9, and 1:10 and the mass ratio of microporous catalyst component to metal oxide component is 1:1, 1:2, 1:3, 1:4, 1:5, 1:6, 1:7, 1:8, 1:9, and 1:10.

After the metal oxide catalyst component has been prepared and combined with a microporous catalyst component, the binder may be added to produce a paste. The binder may be capable of holding the metal oxide catalyst component and the microporous catalyst component together. The paste may be extruded to produce the formulated hybrid catalyst. The formulated hybrid catalyst may be formed by any suitable extrusion process.

Various binders are considered suitable. For example, the binder may include alumina, zirconia, or both. In embodiments, the binder may include pure alumina. In embodiments, the binder may include pure zirconia. When the binder includes alumina, the alumina binder may be a hydrous alumina. A hydrous alumina composition may be prepared from boehemitic precursors with water and a peptizing agent. The binder may be mixed with the metal oxide catalyst component and the microporous catalyst component. After mixing the binder with the metal oxide catalyst component and the microporous catalyst component, the mixture may be extruded, dried, and/or calcined. After calcination, the binder may form aluminum oxide and bind the metal oxide catalyst component and the microporous catalyst component together to provide mechanical strength to extrude the formulated hybrid catalyst. Without being bound by any particular theory, other typically employed binders, such as SiO₂ and TiO₂, may lead to poisoning of the catalyst activity or significant loss in olefin selectivity. The combination of the two catalyst components into a single catalyst body is not trivial. A physical mixture of individually formed metal oxide catalyst component and individually formed microporous catalyst component (i.e., not formed into a single catalyst body) may also reduce the pressure drop over the reactors, however, the catalytic performance, such as hydrocarbon or olefin selectivity and carbon conversion, may drop dramatically. The binder including alumina, zirconia, or both, can combine the metal oxide catalyst component and the microporous catalyst component into a single catalyst body to improve C₂ to C₄ olefin yields and carbon conversion. Individually forming both metal oxide catalyst and microporous catalyst and combining them as a physical mixture is not able to obtain C₂ to C₄ carbon conversion that is obtained with a formulated hybrid catalyst as disclosed and described herein.

In embodiments, the binder may be a colloidal solution, suspension, or gel of a binder precursor. The binder precursor may include oxides or hydroxides of aluminum, oxides or hydroxides of zirconium, or mixtures thereof. In one embodiment, the binder precursor may include pure alumina, (pseudo) boehmite or gibbsite, or mixtures thereof. In other embodiments, the binder precursor may include pure zirconia, hydrous zirconia, or mixtures thereof. In embodiments where the binder includes hydrous alumina, e.g. pseudo-boehmite or gibbsite, acid is typically added as peptization agent. The peptization ratio is defined as the moles of acid added during peptization over the moles of aluminum, ([H⁺]/[Al]). In one or more embodiments, the peptization ratio may have [H⁺]/[Al] ratio of from 0.005 to 0.1, from 0.01 to 0.1, or about 0.05.

In embodiments, the binder may have a surface area of from 25 m²/g to 400 m²/g, from 50 m²/g to 400 m²/g, from 75 m²/g to 400 m²/g, from 100 m²/g to 400 m²/g, from 125 m²/g to 400 m²/g, from 150 m²/g to 400 m²/g, from 100 m²/g to 200 m²/g, from 125 m²/g to 200 m²/g, from 150 m²/g to 200 m²/g, from 25 m²/g to 175 m²/g, from 25 m²/g to 150 m²/g, from 25 m²/g to 125 m²/g, from 25 m²/g to 100 m²/g, from 125 m²/g to 175 m²/g, from 150 m²/g to 175 m²/g, from 100 m²/g to 150 m²/g, from 125 m²/g to 150 m²/g, or from 100 m²/g to 125 m²/g.

Without being bound by any particular theory, the use of templated molecular sieves (e.g. uncalcined) for the formulation has been found to have a positive impact on the catalyst performance and structural properties, particularly when strongly acidic conditions, such as an peptization ratio of more than 0.05, or more than 0.025, are used during the formulation procedure of the formulated hybrid catalysts.

In embodiments, the mixed metal oxide catalyst component and/or the binder are substantially free of silicon and phosphorus. The term “substantially free” may refer to having less than 0.5 weight percent (wt. %) of a certain component in a composition. For example, the metal oxide catalyst component and binder that are substantially free of silicon or phosphorus may have less than 0.5 wt. % silicon or phosphorus based on the combined weight of the metal oxide catalyst component and the binder.

The formulated hybrid catalyst may be used in methods for converting carbon in a carbon-containing feed stream to C₂ to C₄ hydrocarbons. Such processes will be described in more detail below.

According to embodiments, a feed stream is fed into a reaction zone, the feed stream comprising hydrogen (H₂) gas and a carbon-containing gas selected from carbon monoxide (CO), carbon dioxide (CO₂), and combinations thereof. In embodiments, the H₂ gas is present in the feed stream in an amount of from 10 volume percent (vol. %) to 90 vol. %, based on combined volumes of the H₂ gas and the gas selected from CO, CO₂, and combinations thereof. The feed stream is contacted with a formulated hybrid catalyst as disclosed and described herein in the reaction zone. The formulated hybrid catalyst includes a metal oxide catalyst component comprising gallium oxide and zirconia, a microporous catalyst component, and a binder.

Without being bound by a theory, it should be understood that the activity of the formulated hybrid catalyst will be higher for feed streams containing CO as the carbon-containing gas, and that the activity of the formulated hybrid catalyst decreases as a larger portion of the carbon-containing gas in the feed stream is CO₂. However, that is not to say that the formulated hybrid catalyst disclosed and described herein cannot be used in methods where the feed stream includes CO₂ as all, or a large portion, of the carbon-containing gas.

The feed stream is contacted with the formulated hybrid catalyst in the reaction zone under reaction conditions sufficient to form a product stream comprising C₂ to C₄ hydrocarbons. The reaction conditions may include a temperature within the reaction zone ranging, according to one or more embodiments, from 350° C. to 480° C., from 375° C. to 450° C., from 400° C. to 450° C., from 350° C. to 425° C., from 375° C. to 425° C., from 400° C. to 425° C., from 350° C. to 400° C., or from 375° C. to 400° C.

In embodiments, the reaction conditions include a pressure inside the reaction zone of at least 1 bar (100 kilopascals (kPa), such as at least 5 bar (500 kPa), at least 10 bar (1,000 kPa), at least 15 bar (1,500 kPa), at least 20 bar (2,000 kPa), at least 25 bar (2,500 kPa), at least 30 bar (3,000 kPa), at least 35 bar (3,500 kPa), at least 40 bar (4,000 kPa), at least 45 bar (4,500 kPa), at least 50 bar (5,000 kPa), at least 55 bar (5,500 kPa), at least 60 bar (6,000 kPa), at least 65 bar (6,500 kPa), at least 70 bar (7,000 kPa), at least 75 bar (7,500 kPa), at least 80 bar (8,000 kPa), at least 85 bar (8,500 kPa), at least 90 bar (9,000 kPa), at least 95 bar (9,500 kPa), or at least 100 bar (10,000 kPa). In other embodiments, the reaction conditions include a pressure inside the reaction zone is from 5 bar (500 kPa) to 100 bar (10,000 kPa), such as from 10 bar (1,000 kPa) to 95 bar (9,500 kPa), from 15 bar (1,500 kPa) to 90 bar (9,000 kPa), from 20 bar (2,000 kPa) to 85 bar (8,500 kPa), from 25 bar (2,500 kPa) to 80 bar (8,000 kPa), from 30 bar (3,000 kPa) to 75 bar (7,500 kPa), from 35 bar (3,500 kPa) to 70 bar (7,000 kPa), from 40 bar (4,000 kPa) to 65 bar (6,500 kPa), from 45 bar (4,500 kPa) to 60 bar (6,000 kPa), or from 50 bar (5,000 kPa) to 55 bar (5,500 kPa). In embodiments, the pressure inside the reaction zone is from 20 bar (2,000 kPa) to 60 bar (6,000 kPa).

According to embodiments, the gas hourly space velocity (GHSV) within the reaction zone is from 500 per hour (/h) to 12,000/h, such as from 500/h to 10,000/h, from 1,200/h to 12,000/h, from 1,500/h to 10,000/h, from 2,000/h to 9,500/h, from 2,500/h to 9,000/h, from 3,000/h to 8,500/h, from 3,500/h to 8,000/h, from 4,000/h to 7,500/h, from 4,500/h to 7,000/h, from 5,000/h to 6,500/h, or from 5,500/h to 6,000/h. In embodiments the GHSV within the reaction zone is from 1,800/h to 3,600/h, such as from 2,000/h to 3,600/h, from 2,200/h to 3,600/h, from 2,400/h to 3,600/h, from 2,600/h to 3,600/h, from 2,800/h to 3,600/h, from 3,000/h to 3,600/h, from 3,200/h to 3,600/h, or from 3,400/h to 3,600/h. In embodiments, the GHSV within the reaction zone is from 1,800/h to 3,400/h, such as from 1,800/h to 3,200/h, from 1,800/h to 3,000/h, from 1,800/h to 2,800/h, from 1,800/h to 2,600/h, from 1,800/h to 2,400/h, from 1,800/h to 2,200/h, or from 1,800/h to 2,000/h. In embodiments, the GHSV within the reaction is from 2,000/h to 3,400/h, such as from 2,200/h to 3,200/h, from 2,400/h to 3,000/h, or from 2,600/h to 2,800/h.

In embodiments, when using formulated hybrid catalysts disclosed and described herein along with the process conditions disclosed and described herein, the carbon conversion may be improved. Within the process ranges disclosed, the conversion of the feed containing carbon oxides and hydrogen can be carried out in a series of reactors with an intermediate knock-out of water by-product by the means of e.g., phase separation, membrane separation, or some type of water-selective absorptive or adsorptive process. Further, without being bound by a theory, directing the partially converted and water-free effluent to the subsequent reactor in series and repeating this manner of technological operations will have an overall effect of enhancing the hydrocarbon yield.

In embodiments, when using formulated hybrid catalysts disclosed and described herein along with the process conditions disclosed and described herein, the process may have C₂-C₄ olefin selectivity/paraffin selectivity ratio of greater than or equal to 2, such as having C₂-C₄ olefin selectivity/paraffin selectivity ratio greater than or equal to 2, greater than or equal to 3, greater than or equal to 4, greater than or equal to 5, greater than or equal to 10, greater than or equal to 15, or even a C₂-C₄ olefin selectivity/paraffin selectivity ratio of 20.

### EXAMPLES

The following examples illustrate features of the present disclosure but are not intended to limit the scope of the disclosure. For each of the following examples and comparative examples, the microporous catalyst component was prepared as follows: SAPO-34 was synthesized per literature procedures (Lok, B. M.; Messina, C. A.; Patton, R. L.; Gajek, R. T.; Cannan, T. R.; Flanigen, E. M. Crystalline silicoaluminophosphates. U.S. Pat. No. 4,440,871A, 1984). When using calcined SAPO-34, the materials was calcined in air using the following program: 25° C. raise to 600° C. at a heating rate of 5° C./min, hold at 600° C. for 4 hours (h), cool down to 25° C. in 4 h. The material was sieved to a fraction smaller than 200 mesh (smaller than 75 m).

### Mercury (Hg) Porosimetry of Different ZrO₂ Supports

The mercury (Hg) porosimetry analysis was performed on a Micromeritics Autopore IV 9520. The samples were mechanically outgassed while under vacuum prior to mercury analysis to remove any physiosorbed species (i.e., moisture) from the sample's surface.

Test conditions include Hg fill pressure=0.50 psia, Hg contact angle=130°, Hg surface tension=485 dyn/cm, Hg density=13.53 g/mL, 30-minute evacuation time, small bore penetrometer (solid type: 0.392 stem volume) with 5-cc bulb, 30 second equilibration time, 92-point pressure table (75 intrusion plus 17 extrusion pressure points), and mechanical evacuation <50 m Hg. The low to high pressure cross over point was collected at approximately 46 psia. The pressure table used was generated to allow an even incremental distribution of pressures on a log scale from 0.5 to 60,000 psia and is used for detecting pore size from 0.003-400 m diameter. The mercury is forced into smaller and smaller pores as pressure is increased incrementally from a vacuum to a maximum of nearly 60,000 psia. Table 1 below demonstrates the resulting macroporosity fraction of each zirconia support calculated by dividing the total intrusion volume of the 80-500 nm pores by the total intrusion volume of the 3-500 nm pores.

TABLE 1

| | Total Intrusion | Total Intrusion | |
|---|---|---|---|
| | Volume | Volume | |
| | 3-500 nm | 80-500 nm | |
| ZrO₂ Support | (mL/g) | (mL/g) | φ_{macro} |
| RC-100 | 0.703 | 0.462 | 0.657 |
| MEL XZO1501/25 | 0.570 | 0.141 | 0.247 |
| (ZrO2) | | | |
| DKKK Z3186 | 0.217 | 0.019 | 0.086 |
| DKKK Z3101 | 0.354 | 0.162 | 0.458 |
| NorPro SZ31164 | 0.294 | 0.0406 | 0.138 |

The RC-100 ZrO₂ support described in this disclosure is available from Daiichi Kigenso Kagaku-Kogyo Co., Ltd with the tradename RC-100. The MEL XZ01501/25 ZrO₂ support described in this disclosure is available from MEL Chemicals Inc. with the tradename or series name XZO1501/25. The DKKK Z3186 ZrO₂ support described in this disclosure is available from Daiichi Kigenso Kagaku-Kogyo Co., Ltd. with the tradename Z3186. The DKKK Z3101 ZrO₂ support described in this disclosure is available from Daiichi Kigenso Kagaku-Kogyo Co., Ltd. with the tradename Z3101. The NorPro SZ31164 ZrO₂ support described in this disclosure is a ZrO₂ support with the product code SZ31164 that is manufactured by Saint-Gobain NorPro.

### Example 1

A metal oxide catalyst component comprising gallium on a zirconia support was prepared by an incipient wetness impregnation method. An impregnation solution of Ga(NO₃)₃·xH₂O and La(NO₃)₃·6H₂O with a concentration of respectively 1 mol/L and 0.3 mol/L in deionized water was prepared. 10 grams of <200 mesh ZrO₂ support (NORPRO SZ31164, >95% monoclinic phase by XRD, pore volume=0.4 mL/g measured by deionized water) was weighed and placed into a glass vial. After that, 4 mL of the Ga and La impregnation solution was added dropwise to the support while constantly shaking. After impregnation, the catalyst was dried at 85° C. in the oven overnight and then subsequently heated at increasing intervals of 3° C./min until 550° C. temperature was reached and kept at that temperature for 4 hours. After calcination, the catalyst was re-sieved to <200 mesh (75 m) to remove larger agglomerated particles.

A hybrid catalyst was prepared by mixing 8 grams of the metal oxide catalyst component described above with 1.808 grams of uncalcined SAPO-34 (<200 mesh size (75 m)) for 10 minutes using a mortar and pestle. Separately, pseudoboehmite (AlOOH) (manufactured by Sasol Limited, tradename Catapal D) was peptized in water using HNO₃ (65 wt. % in H₂O) at a [HNO₃]/[Al] ratio of 0.05, and a total solid content of 35 wt. %. The peptized pseudoboehmite mixture was added to the dry mixed powders, targeting a pseudoboehmite concentration of 24.6 wt. % on total solids basis. The paste was subsequently mixed for at least 10 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Example 2

A metal oxide catalyst component comprising gallium on a zirconia support was prepared by an incipient wetness impregnation method. An impregnation solution of Ga(NO₃)₃·xH₂O and La(NO₃)₃·6H₂O with a concentration of respectively 0.72 mol/L and 0.22 mol/L in deionized water was prepared. 10 grams of ZrO₂ support (DKKK Z3186, >94% monoclinic phase by XRD, pore volume=0.55 mL/g measured by deionized water) was weighed and placed into a glass vial. After that, 5.5 mL of the Ga and La impregnation solution was added dropwise to the support while constantly shaking. After impregnation, the catalyst was dried at 85° C. in the oven overnight and subsequently heated at increasing intervals of 3° C./min until 550° C. temperature was reached and then kept at that temperature for 4 hours. After calcination, the catalyst was sieved to <200 mesh (75 m) to remove larger agglomerated particles.

A hybrid catalyst was prepared by mixing 8 grams of the metal oxide catalyst component described above with 1.808 grams of uncalcined SAPO-34 (<200 mesh size (75 m)) for 10 minutes using a mortar and pestle. Separately, pseudoboehmite (AlOOH) (manufactured by Sasol Limited, tradename Catapal D) was peptized in water using HNO₃ (65 wt. % in H₂O) at a [HNO₃]/[Al] ratio of 0.05, and a total solid content of 35 wt. %. The peptized pseudoboehmite mixture was added to the dry mixed powders, targeting a pseudoboehmite concentration of 24.6 wt. % on total solids basis. The paste was subsequently mixed for at least 10 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Example 3

A metal oxide catalyst component comprising gallium on a zirconia support was prepared by an incipient wetness impregnation method. An impregnation solution of Ga(NO₃)₃·xH₂O and La(NO₃)₃·6H₂O with a concentration of respectively 0.8 mol/L and 0.24 mol/L in deionized water was prepared. 10 grams of ZrO₂ support (XZO1501/25 MEL Chemicals, 73% monoclinic phase by XRD, pore volume=0.5 mL/g measured by deionized water) was weighed and placed into a glass vial. After that, 5 mL of the Ga and La impregnation solution was added dropwise to the support while constantly shaking. After impregnation, the catalyst was dried at 85° C. in the oven overnight and subsequently heated at increasing intervals of 3° C./min until 550° C. was reached and then kept at that temperature for 4 hours. After calcination, the catalyst was sieved to <200 mesh (75 m) to remove larger agglomerated particles.

A hybrid catalyst was prepared by mixing 8 grams of the metal oxide catalyst component described above with 1.808 grams of uncalcined SAPO-34 (<200 mesh size (75 μm)) for 10 minutes using a mortar and pestle. Separately, pseudoboehmite (AlOOH) (manufactured by Sasol Limited, tradename Catapal D) was peptized in water using HNO₃ (65 wt. % in H₂O) at a [HNO₃]/[Al] ratio of 0.05, and a total solid content of 35 wt. %. The peptized pseudoboehmite mixture was added to the dry mixed powders, targeting a pseudoboehmite concentration of 24.6 wt. % on total solids basis. The paste was subsequently mixed for at least 10 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Example 4

A metal oxide catalyst component was prepared according to Example 2.

A hybrid catalyst was prepared by mixing 4 grams of the metal oxide catalyst component described above with 1 gram of uncalcined SAPO-34 (<200 mesh size (75 μm)) for 2 minutes using a mortar and pestle. Separately, 15 mL of a 20 wt. % zirconium acetate solution (Daiichi Kigenso Kagaku-Kogyo Co., Ltd., tradename Zircosol ZA-20) was partially neutralized by slowly adding a 20 wt. % ammonium zirconium carbonate (AZC) solution (Daiichi Kigenso Kagaku-Kogyo Co., Ltd., tradename Zircosol AC-20) at approximately 50° C. under stirring until a pH of 5-6 was obtained (addition of a total of 1.8 mL AZC solution). The Zr-containing binder solution was added to the dry mixed powders, targeting a final ZrO₂ binder concentration of 20 wt. % on total solid basis. The paste was subsequently mixed for at least 15 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature and then held at that temperature for 4 hours. After calcination, the hybrid catalyst was crushed and sieved to 40-80 mesh for testing.

### Comparative Example 1

A metal oxide catalyst component comprising gallium on a zirconia support was prepared by an incipient wetness impregnation method. An impregnation solution of Ga(NO₃)₃·xH₂O and La(NO₃)₃·6H₂O with a concentration of respectively 0.57 mol/L and 0.17 mol/L in deionized water was prepared. 10 grams of ZrO₂ support (RC-100, >94% monoclinic phase by XRD, pore volume=0.7 mL/g measured by deionized water) was weighed and placed into a glass vial. After that, 7 mL of the Ga and La impregnation solution was added dropwise to the support while constantly shaking. After impregnation, the catalyst was dried at 85° C. in the oven overnight and subsequently heated at increasing intervals of 3° C./min until 550° C. temperature was reached and then kept at that temperature for 4 hours. After calcination, the catalyst was sieved to <200 mesh (75 m) to remove larger agglomerated particles.

A hybrid catalyst was prepared by mixing 8 grams of the metal oxide catalyst component described above with 1.808 grams of uncalcined SAPO-34 (<200 mesh size (75 m)) for 10 minutes using a mortar and pestle. Separately, pseudoboehmite (AlOOH) (manufactured by Sasol Limited, tradename Catapal D) was peptized in water using HNO₃ (65 wt % in H₂O) at a [HNO₃]/[Al] ratio of 0.05, and a total solid content of 35 wt. %. The peptized pseudoboehmite mixture was added to the dry mixed powders, targeting a pseudoboehmite concentration of 24.6 wt. % on total solids basis. The paste was subsequently mixed for at least 10 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Comparative Example 2

A metal oxide catalyst component comprising gallium on a zirconia support was prepared by an incipient wetness impregnation method. An impregnation solution of Ga(NO₃)₃·xH₂O and La(NO₃)₃·6H₂O with a concentration of respectively 0.59 mol/L and 0.18 mol/L in deionized water was prepared. 10 grams of ZrO₂ support (DKKK Z3101, BET surface area=80 m²/g, pore volume=0.68 mL/g measured by deionized water) was weighed and placed into a glass vial. After that, 6.8 mL of the Ga and La impregnation solution was added dropwise to the support while constantly shaking. After impregnation, the catalyst was dried at 85° C. in the oven overnight and subsequently heated at increasing intervals of 3° C./min until 550° C. temperature was reached and then kept at that temperature for 4 hours. After calcination, the catalyst was sieved to <200 mesh (75 m) to remove larger agglomerated particles.

A hybrid catalyst was prepared by mixing 8 grams of the metal oxide catalyst component described above with 1.808 grams of uncalcined SAPO-34 (<200 mesh size (75 m)) for 10 minutes using a mortar and pestle. Separately, pseudoboehmite (AlOOH) (manufactured by Sasol Limited, tradename Catapal D) was peptized in water using HNO₃ (65 wt % in H₂O) at a [HNO₃]/[Al] ratio of 0.05, and a total solid content of 35 wt. %. The peptized pseudoboehmite mixture was added to the dry mixed powders, targeting a pseudoboehmite concentration of 24.6 wt. % on total solids basis. The paste was subsequently mixed for at least 10 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Comparative Example 3

A metal oxide catalyst component was prepared according to Comparative Example 1.

A hybrid catalyst was prepared by mixing 4 grams of the metal oxide catalyst component described above with 1 gram of uncalcined SAPO-34 (<200 mesh size (75 μm)) for 2 minutes using a mortar and pestle. Separately, 15 mL of a 20 wt. % zirconium acetate solution (Daiichi Kigenso Kagaku-Kogyo Co., Ltd., tradename Zircosol ZA-20) was partially neutralized by slowly adding a 20 wt. % ammonium zirconium carbonate (AZC) solution (Daiichi Kigenso Kagaku-Kogyo Co., Ltd., tradename Zircosol AC-20) at approximately 50° C. under stirring until a pH of 5-6 was obtained (addition of a total of 1.8 mL AZC solution). The Zr-containing binder solution was added to the dry mixed powders, targeting a final ZrO₂ binder concentration of 20 wt. % on total solid basis. The paste was subsequently mixed for at least 15 minutes using a mortar and pestle until an extrudable paste was obtained. The paste was transferred to a ceramic dish and dried at 85° C. overnight. The dried precursor was heated in a static muffle furnace at increasing intervals of 2° C./min until 600° C. temperature was reached and then held at that temperature for 4 hours. After calcination, the hybrid catalyst was crushed and sieved to 40-80 mesh for testing.

### Catalytic Performance Data

Testing of the hybrid catalysts was performed in a stainless steel fixed bed reactor system (7.7 mm internal diameter) under the following conditions: 420° C., H₂/CO=3, pressure=40 bar, WHSV=1.54 hr⁻¹.

Prior to contacting with syngas, the catalyst was heated under nitrogen (N₂) to reaction temperature and pressure. The reactor effluent composition was obtained by gas chromatography and the conversion and carbon based selectivities are calculated using the following equations:

$${X}_{CO} ( \% ) = [ ( η CO , in - η CO , out ) / η CO , in ] \cdot 100 \qquad ( 1 )$$

$${S}_{j} ( \% ) = [ {α}_{j} \cdot {η}_{j} , out / η CO , in - η CO , out ) ] \cdot 100 \qquad ( 2 )$$

where X_{CO} is defined as the CO conversion (%), η_{CO, in} is defined as the molar inlet flow of CO (μmol/s), η_{CO, out} is the molar outlet flow of CO (μmol/s), Sⱼ is defined as the carbon based selectivity to product j (%), αⱼ the number of carbon atoms for product j, and η_{j, out} is the molar outlet flow of product j (μmol/s).

The results of the catalytic testing are shown in Table 2 below. The reported conversion values are the averaged conversion levels between 50 hours and 150 hours of time on stream (TOS). The normalized deactivation rate a is calculated by fitting the data between 24 hours and 150 hours to a logarithmic decay: X/X₀=a+k*ln(TOS(h)).

TABLE 2

| | | | | | C2-C5 | C2-C4 | |
|---|---|---|---|---|---|---|---|
| | | | X(CO) | K (%/ | Paraffin | Olefin | |
| | Φ_{macro} | Binder | (%) | ln(h)⁻¹) | Sel (%) | Sel (%) | O/P |
| Ex. 1 | 0.138 | Al₂O₃ | 61.0 | −0.025 | 9 | 51.4 | 5.7 |
| Ex. 2 | 0.086 | Al₂O₃ | 63.2 | −0.026 | 8.9 | 51.8 | 5.8 |
| Ex. 3 | 0.247 | Al₂O₃ | 56.6 | −0.030 | 8.4 | 51.7 | 6.1 |
| Ex. 4 | 0.086 | ZrO₂ | 61.0 | −0.026 | 10 | 51.2 | 5.1 |
| Comp. | 0.657 | Al₂O₃ | 48.9 | −0.061 | 10.5 | 47.0 | 4.5 |
| Ex. 1 | | | | | | | |
| Comp. | 0.458 | Al₂O₃ | 45.2 | −0.055 | 10.9 | 46 | 4.2 |
| Ex. 2 | | | | | | | |
| Comp. | 0.657 | ZrO₂ | 60.4 | −0.050 | 10.1 | 51.3 | 5.1 |
| Ex. 3 | | | | | | | |

As can be observed in Table 2, bifunctional catalyst formulations based on metal oxide catalysts showing a macroporosity fraction (φ_{macro}) less than 0.3 (Examples 1-4) show both higher conversion and a lower deactivation rate k compared to bifunctional catalyst formulations with metal oxide catalysts with φ_{macro} greater than 0.3 (Comparative Examples 1-3). This behavior is generically observed, independent of the polymorphism of the ZrO₂ (Example 4) or the nature of the binder (Comparative Examples 1 and 3).

The present disclosure includes one or more non-limiting aspects. A first aspect includes a process for preparing C₂ to C₄ hydrocarbons comprising: introducing a feed stream comprising hydrogen gas and a carbon-containing gas selected from the group consisting of carbon monoxide, carbon dioxide, and mixtures thereof into a reaction zone of a reactor; and converting the feed stream into a product stream comprising C₂ to C₄ hydrocarbons in the reaction zone in the presence of a formed hybrid catalyst, the formed hybrid catalyst comprising: a metal oxide catalyst component comprising gallium oxide and zirconia, wherein the zirconia has a macroporosity fraction that is less than 0.3; a microporous catalyst component that is a molecular sieve having 8-MR (Membered Ring) pore openings; and a binder comprising alumina, zirconia, or mixtures thereof.

A second aspect includes a process for preparing a formed hybrid catalyst, the process comprising: mixing a metal oxide catalyst component and a microporous catalyst component, wherein: the metal oxide catalyst component comprises gallium oxide and zirconia, wherein the zirconia has a macroporosity fraction that is less than 0.3; and the microporous catalyst component comprises a molecular sieve having 8-MR (Member Ring) pore openings; adding a binder to the metal oxide catalyst component and the microporous catalyst component to form a paste, wherein the binder is a colloidal solution, suspension, or gel of a binder precursor comprising oxides or hydroxides of aluminum, oxides or hydroxides of zirconium, or mixtures thereof; and extruding the paste to produce the formed hybrid catalyst.

A third aspect includes any above aspect, wherein the paste is calcined after extruding.

A fourth aspect includes any above aspect, wherein the zirconia has a macroporosity fraction that is less than 0.25.

A fifth aspect includes any above aspect, wherein the zirconia has a macroporosity fraction that is less than 0.20.

A sixth aspect includes any above aspect, wherein the metal oxide catalyst component further comprises nickel, palladium or platinum.

A seventh aspect includes any above aspect, wherein the formed hybrid catalyst has a particle size of from 0.5 mm to 6 mm.

An eighth aspect includes any above aspect, wherein the formed hybrid catalyst has a particle size of less than 3.0 mm.

A ninth aspect includes any above aspect, wherein the metal oxide catalyst component comprises from 0.1 wt. % to 10 wt. % of gallium.

A tenth aspect includes any above aspect, wherein the microporous catalyst component comprises SAPO-34.

An eleventh aspect includes any above aspect, wherein the microporous catalyst component comprises uncalcined SAPO-34.

A twelfth aspect includes any above aspect, wherein the binder comprises pure alumina.

A thirteenth aspect includes any above aspect, wherein the binder comprises pure zirconia.

A fourteenth aspect includes any above aspect, wherein the metal oxide catalyst component comprises from 40.0 wt. % to 85.0 wt. % of the formed hybrid catalyst.

A fifteenth aspect includes any above aspect, wherein the C₂-C₄ hydrocarbons predominantly comprises C₂-C₄ olefins.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in embodiments, the first component “consists” or “consists essentially of” that second component. It should further be understood that where a first component is described as “comprising” a second component, it is contemplated that, in embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

For the purposes of describing and defining the present inventive technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

1. A process for preparing C₂ to C₄ hydrocarbons comprising:
introducing a feed stream comprising hydrogen gas and a carbon-containing gas selected from the group consisting of carbon monoxide, carbon dioxide, and mixtures thereof into a reaction zone of a reactor; and
converting the feed stream into a product stream comprising C₂ to C₄ hydrocarbons in the reaction zone in the presence of a formed hybrid catalyst, the formed hybrid catalyst comprising:
a metal oxide catalyst component comprising gallium oxide and zirconia, wherein the zirconia has a macroporosity fraction that is less than 0.3;
a microporous catalyst component that is a molecular sieve having 8-MR (Membered Ring) pore openings; and
a binder comprising alumina, zirconia, or mixtures thereof.

2. A process for preparing a formed hybrid catalyst, the process comprising:
mixing a metal oxide catalyst component and a microporous catalyst component, wherein:
the metal oxide catalyst component comprises gallium oxide and zirconia, wherein the zirconia has a macroporosity fraction that is less than 0.3; and
the microporous catalyst component comprises a molecular sieve having 8-MR (Member Ring) pore openings;
adding a binder to the metal oxide catalyst component and the microporous catalyst component to form a paste, wherein the binder is a colloidal solution, suspension, or gel of a binder precursor comprising oxides or hydroxides of aluminum, oxides or hydroxides of zirconium, or mixtures thereof; and
extruding the paste to produce the formed hybrid catalyst.

3. The process of claim 2, wherein the paste is calcined after extruding.

4. The process of claim 1, wherein the zirconia has a macroporosity fraction that is less than 0.25.

5. The process of claim 1, wherein the zirconia has a macroporosity fraction that is less than 0.20.

6. The process of claim 1, wherein the metal oxide catalyst component further comprises nickel, palladium or platinum.

7. The process of claim 1, wherein the formed hybrid catalyst has a particle size of from 0.5 mm to 6 mm.

8. The process of claim 1, wherein the formed hybrid catalyst has a particle size of less than 3.0 mm.

9. The process of claim 1, wherein the metal oxide catalyst component comprises from 0.1 wt. % to 10 wt. % of gallium.

10. The process of claim 1, wherein the microporous catalyst component comprises SAPO-34.

11. The process of claim 1, wherein the microporous catalyst component comprises uncalcined SAPO-34.

12. The process of claim 1, wherein the binder comprises pure alumina.

13. The process of claim 1, wherein the binder comprises pure zirconia.

14. The process of claim 1, wherein the metal oxide catalyst component comprises from 40.0 wt. % to 85.0 wt. % of the formed hybrid catalyst.

15. The process of claim 1, wherein the C₂-C₄ hydrocarbons predominantly comprises C₂-C₄ olefins.

16. The process of claim 2, wherein the zirconia has a macroporosity fraction that is less than 0.20.

17. The process of claim 2, wherein the metal oxide catalyst component further comprises nickel, palladium or platinum.

18. The process of claim 2, wherein the formed hybrid catalyst has a particle size of from 0.5 mm to 6 mm.
